(19) United States
(12) Patent Application Publication
(10) Pub. No.: US 2008/0130124 A1
(43) Pub. Date: Jun. 5, 2008

(54) Reflection-Safe Receiver for Power Beaming

(75) Inventor: David S. Graham, Mountain View, CA (US)

Correspondence Address: FENWICK & WEST LLP, SILICON VALLEY CENTER, 801 CALIFORNIA STREET, MOUNTAIN VIEW, CA, 94041, US

(73) Assignee: PowerBeam, Inc., Sunnyvale, CA (US)

(21) Appl. No.: 11/943,903

(22) Filed: Nov. 21, 2007

Related U.S. Application Data
(60) Provisional application No. 60/866,807, filed on Nov. 21, 2006.

(51) Int. Cl. G02B 27/00

(52) U.S. Cl. 359/614

(57) ABSTRACT

Embodiments of the invention include a power beam receiver that will not reflect light beyond the regulatory limits for human exposure, except along paths known to be without people. In one embodiment, a baffle is used to trap reflections from surfaces of the receiver. In a second embodiment, the power beam receiver is arranged so that reflections are reflected to another surface of the receiver. These surfaces may be designed as a retroreflector. In a third embodiment, an intentional scattering medium is added to the power beam receiver so that parallel light rays incident on the front surface of the power beam receiver are scattered through a series of angles. As a result, any light escaping the system is diffused.

### CROSS REFERENCE TO RELATED APPLICATION

This application claims priority under 35 U.S.C. § 119(e) to U.S. Provisional Patent Application No. 60/866,807 filed Nov. 21, 2006, which is hereby incorporated by reference in its entirety.

### BACKGROUND OF THE INVENTION

1. Field of the Invention

This invention relates to the receive portion of a power beam system. More specifically, it relates to a power beam receiver that limits reflection of the incident radiation for increased safety.

2. Description of the Related Art

Prior power beaming systems are unsafe for use around people not wearing eye protection. A human proximate to a power beaming system can be hurt in two ways. First, a person can receive power directly from the transmitter—a person could look into the beam. The reader should assume that the incident beam path is protected from intrusion. In a power beam system where the beam path is not protected from intrusion, a power beam exceeding human exposure limits is unsafe. Second, a person can receive unsafe levels of light reflected from a surface in the path of the beam. That surface might be accidentally inserted in the beam path, or it might be part of the power beaming receiver. Even a power beaming receiver with anti-reflection coated surfaces is potentially a source of unsafe reflections because it is subject to contamination with water, oil, or other reflective material. Power beaming systems are not currently designed to limit reflections to be within regulatory limits for human exposure. For example, U.S. Pat. Nos. 5,982,139, 6,114,834, 6,792,259, and 7,068,991 all by inventor Ronald J. Parise, describe remote charging systems for vehicles and electronic devices, but do not treat reflections that will occur nor discuss methods of reducing reflections.

The laser power beaming systems for the NASA aircraft experiment at Huntsville, Ala., and all entrants in the NASA space elevator competitions, as well as other systems described in patent filings, have a power conversion element perpendicular to the incident radiation. FIG. 1A illustrates an example of this arrangement. The power receiving element 10 is perpendicular to incident light 11. This method is efficient, but it is generally unsafe. There is no control over where the reflections go. If the power conversion element is at even a small angle to the incident light, the light is likely to reflect in an unsafe direction.

Free space optical telecommunication systems, such as those that were made by Terabeam, Inc. of San Jose, Calif., use a perpendicular conversion element. Because these systems are designed to be mounted up high, far from people, and because they can have a long baffle on the front of the receiver, it is very unlikely that any human will receive radiation beyond the regulatory limits, despite the use of a perpendicular power conversion element. Generally these systems use small photodiodes. To collect light onto them, they use large front lenses. FIG. 1B illustrates an example of this arrangement. Light 11 is focused onto power receiving element 10 by lens 90. This approach might not be safe in a situation where people were nearby. Moreover, it requires sufficient depth to allow for the lens to concentrate the light on the photodiode. The angle between the incident light and the first surface (the lens) must be closely controlled, presumably perpendicular.

### SUMMARY

Embodiments of the invention include a power beam receiver that will not reflect light beyond the regulatory limits for human exposure, except along paths known to be without people. Even when the first surface that the power beam impinges on (the “front surface”) is contaminated with water, oil, or other reflective material, the power beam receiver will not reflect light such that a human exposure exceeds regulatory limits.

In one embodiment, the power beam receiver is arranged so that any part of a power beam within an acceptance cone that is reflected from the front surface or secondary surfaces of the receiver is trapped by a baffle.

In a second embodiment, the power beam receiver is arranged so that any part of a power beam incident from any angle within an acceptance cone that is reflected is reflected to another surface of the photoreceiver. These surfaces may be designed as a retroreflector.

In a third embodiment, an intentional scattering medium is added to the power beam receiver so that parallel light rays incident on the front surface of the power beam receiver are scattered through a series of angles. As a result, any light escaping the system is diffused.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A shows a prior art a power conversion element perpendicular to the incident light, which is assumed to be collimated.

FIG. 1B shows a prior art a power conversion element behind a concentrating lens perpendicular to the incident light, which is assumed to be collimated.

FIG. 2A is an illustration of a power beam receiver where the power conversion elements are arranged to reflect incident light into a baffle, in accordance with one embodiment.

FIG. 2B is an illustration of a power beam receiver where an off-axis parabolic mirror is used to concentrate incident light on a power conversion element, and where reflections from the power conversion element are trapped by a baffle in accordance with one embodiment.

FIG. 2C is an illustration of the system in FIG. 2B where the power conversion element is angled in accordance with one embodiment.

FIG. 2D is an illustration of an off-axis parabolic mirror used in FIG. 2B.

FIG. 2E is a perspective view of an off-axis parabolic mirror of FIG. 2D.

FIG. 2F illustrates a plurality of parabolic mirrors mounted in an assembly, in accordance with one embodiment.

FIG. 3A is an illustration of a power beam receiver where the surfaces on which the incident light impinges are arranged to reflect incident light onto other surfaces of the receiver, in accordance with one embodiment.

FIG. 3B is an illustration of a power beam receiver where the surfaces on which the incident light impinges are arranged to reflect incident light onto other surfaces of the receiver, in accordance with one embodiment.

FIG. 3C is an illustration of a power beam receiver where the front surface comprises corner cube retroreflectors.

FIG. 4A is an illustration of a power beam receiver where an intentional dispersion medium is inserted to increase the angles of the incident light upon reflection, in accordance with one embodiment.

FIG. 4B is a view of the arrangement of FIG. 4A showing a border around the receiver.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

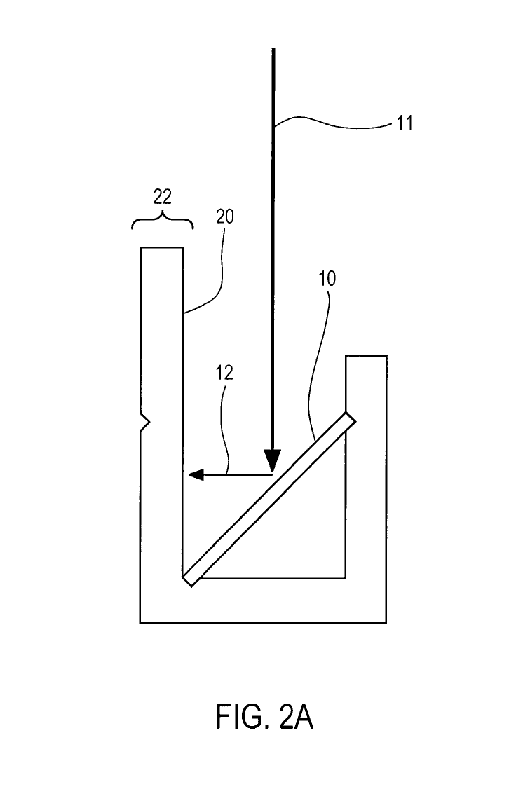

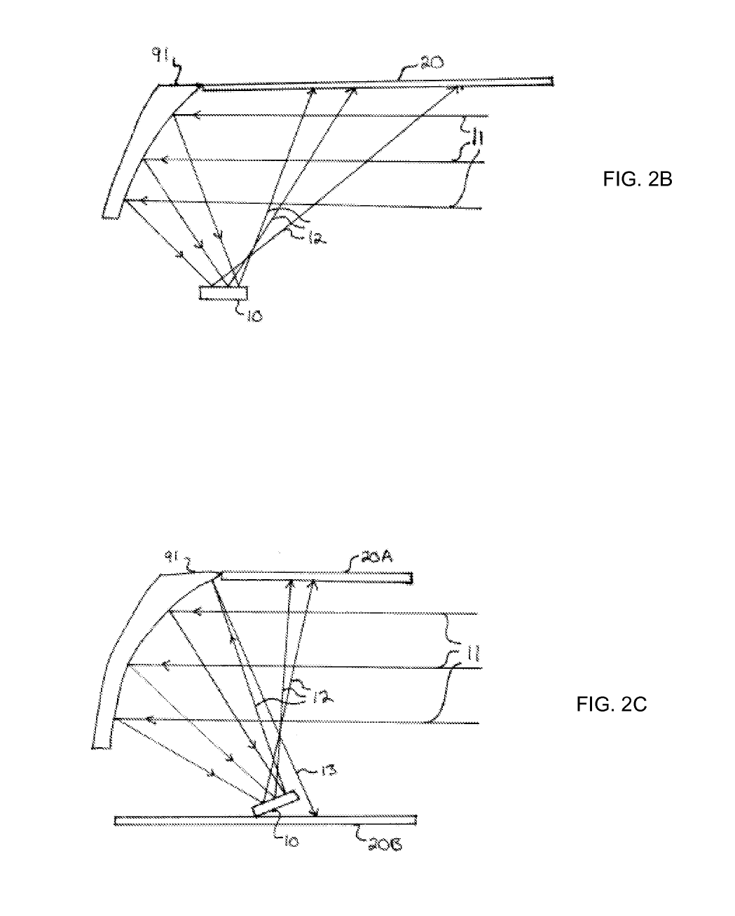

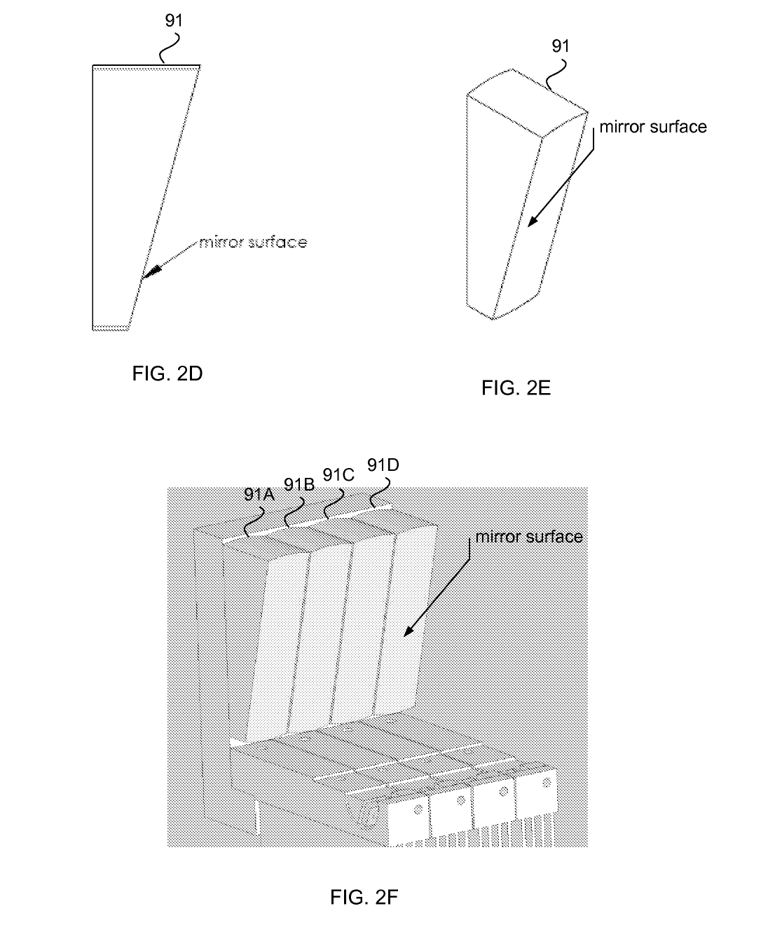

FIG. 2A is an illustration of one power conversion element 10 of a power beam receiver arranged to reflect incident light 11 into a baffle 20, in accordance with one embodiment. In this embodiment, power receiving element 10 is tilted with respect to the incoming beam 11. For illustration purposes, only a single power conversion element 10 with a single baffle is shown, but multiple power conversion elements arranged at the same or different angles with multiple baffles can be included in a power beam receiver, for example in a line or grid pattern.

For many practical power beaming systems, power receiving element 10 will be one or more photodiodes. All light reflected 12 from its surface is trapped by a baffle 20. Baffle 20 can be made of any material that overwhelmingly absorbs light at least at the wavelength at which the system operates. Example materials include black anodized aluminum or a rigid material covered in a light-absorptive cloth. In FIG. 2A, there is no lens in front of power receiving element 10. Alternatively, an angled and baffled optic can be placed there. In the arrangement shown in FIG. 2A, if the front element were flat, slightly angled, or gently rounded, reflection from the surface might escape and cause a safety problem. Even if the surfaces were anti-reflection coated, a practical power beaming system is likely to be used in a situation where dust, water, grease, or other contamination causes reflection. FIG. 2A shows the angle of the tilt of the power receiving element 10 as 45 degrees, but other angles can also be used. The power receiving element 10 can be made in many sizes, and generally smaller is better because the smaller the power receiving element 10, the shorter the baffle 20 and the thinner the receiver. The downside to this is that the thickness 22 of baffle 20 represents lost area coverage, and the greater the number of baffles 20, the greater the lost area, and therefore the less efficient the system. The optimum sizes depend heavily on the requirements of the application. This embodiment is preferred when the light is from a known direction, preferably straight-on as illustrated by incident light 11 which is at 45 degrees to the power receiving element 10 shown in FIG. 2A. If the power beam 11 enters at an angle, the baffles must be taller, and they begin to mask the power receiving elements 10. The power receiving elements 10 will usually have surface coatings 40 (not shown in FIG. 2A), as described below.

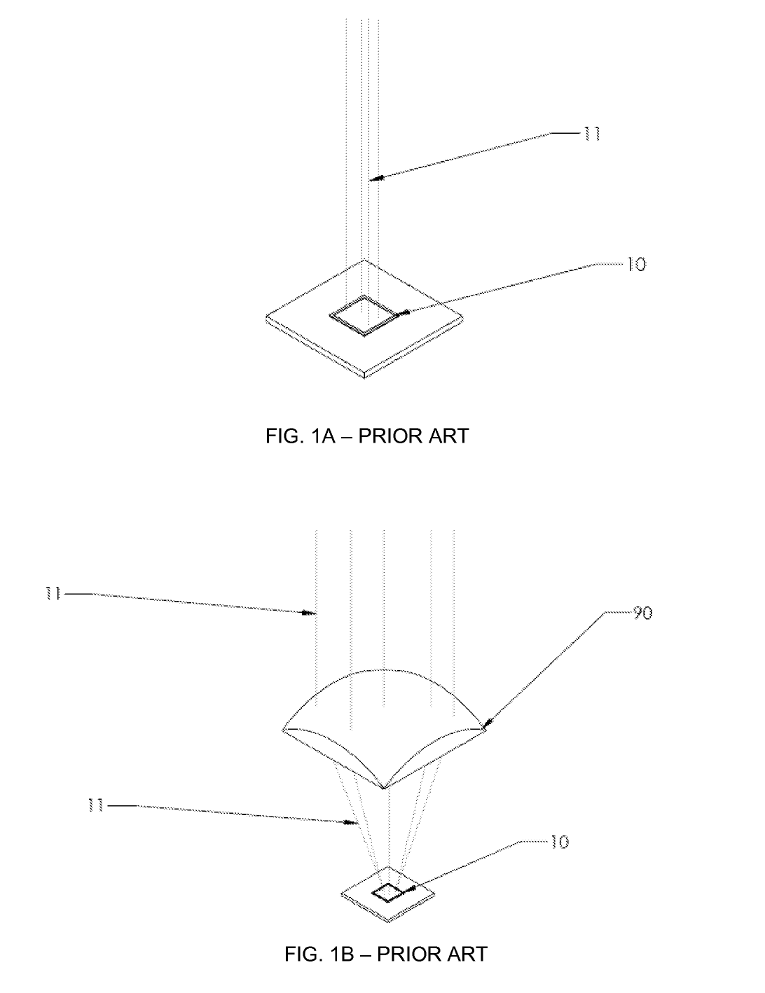

Although the arrangement of FIG. 2A, as shown, requires approximately 1.4 times as much surface area for the same effective area of the power receiving element 10, it is safe from reflection. The perpendicular method illustrated in FIG. 1A uses less material, and, if the beam is perpendicularly incident, the reflection from the surface will be back to the transmitter (ignoring diffraction), which is assumed to be a safe path, provided the incident angle is guaranteed to great precision. For example, assume the power beam is incident from 20 meters, so the total optical path will be 40 meters from the power beam transmitter to the receiver and back. Assume the power beam has a width of 100 mm. Assume the transmitter has a width of 250 mm (the extra width might be for any reason, including to baffle the reflections from the power beam receiver). However, if the angle exceeds 0.001875 rad (0.10743 degrees), the reflection will not be baffled by the transmitter. This 0.001875 rad tolerance includes tolerance for diffraction, for the non-ideal characteristics of the lens train, and for the mechanical tolerances related to manufacturing spread, thermal creep, lash, and operation tolerances. Even assuming one could account for all these variables, the transmitter still must be designed not to re-reflect the retroreflected light to unanticipated positions. A perpendicular power conversion element with a curved lens in front would have the potential advantage of reflecting through a series of angles, which would tend to reduce the power density of the reflected beam. However, at the same time, it would increase the amount of light scattered outside the beam path. Moreover, as the focal length became shorter, the lens would become more highly curved, increasing this effect. The arrangement of FIG. 2A is a simpler solution for assuring that reflections are safely treated.

FIG. 2B shows another embodiment of the invention wherein concentration is used. Parabolic reflector 91 focuses incident light 11 onto power conversion element 10. Light 12 reflected from the surface of power conversion element 10 is trapped by Baffle 20. As with FIG. 2A, all reflected light can be captured.

The main advantage of the system described in FIG. 2B over FIG. 2A is economy: It requires a lot less material for the power conversion element 10. Specifically, InGaAs diodes operating at 1450 nm operate with concentrations of 500 suns. Both systems require that the light be incident at a known angle. Parabolic reflectors 91 can be on-axis or off-axis. The choice mostly relates to convenience, although there are efficiency issues as well. Off-axis parabolic reflectors, such as those made by Janostech Technology, Inc. of Keene, N.H., can be bought in 30 degree, 60 degree, and 90 degree variants. In production volumes, one can use a metalized injection molded plastic part which is both cheap and convenient. The advantages of a parabolic reflector over a lens are particularly profound from 1400 nm to 1500 nm, where most plastic lenses absorb heavily. The reflector is cheaper than glass lenses and 99 percent efficient. Moreover, there is much less concern with contamination than with a lens. If the parabolic reflector 91 is contaminated by something reflective and conformal, there is no harm. The same cannot be said of a lens as described in FIG. 1B. An example of a suitable parabolic reflector 91 is illustrated in FIGS. 2D and 2E. A plurality of parabolic reflectors 91A-D mounted in an assembly is illustrated in FIG. 2F.

FIG. 2C shows a version of FIG. 2B where the power conversion element 10 is set at an angle so that is not parallel to the incident radiation 11. This can reduce the length of the top baffle 20A at the cost of requiring a bottom baffle 20B to absorb the light 13 that twice reflects from the parabolic reflector 91. Specifically, some portion of the incident light 11 first reflects from the parabolic reflector 91, then reflects 12 from the power conversion element 10, and reflects again 13 from the parabolic reflector 91. Because any incident light 11 that hits the power conversion element 10 on a perpendicular will be reflected back where it came, it is important to choose the angle of power conversion element 10 with this in mind.

It should be recognized by one of ordinary skill in the art that the arrangement of an on-axis parabolic reflector 91 with a power conversion element 10 at 45 degrees to the incident light 11 will perform substantially similarly to the system described in FIG. 2A. The optical path is just being concentrated, and there is some small masking due to the size of the power conversion element 10 and its mechanical support (not shown). Likewise, the systems described in FIG. 2B and FIG. 2C operate with the same optical elements. The optical elements are simply moved and altered for convenience and efficiency.

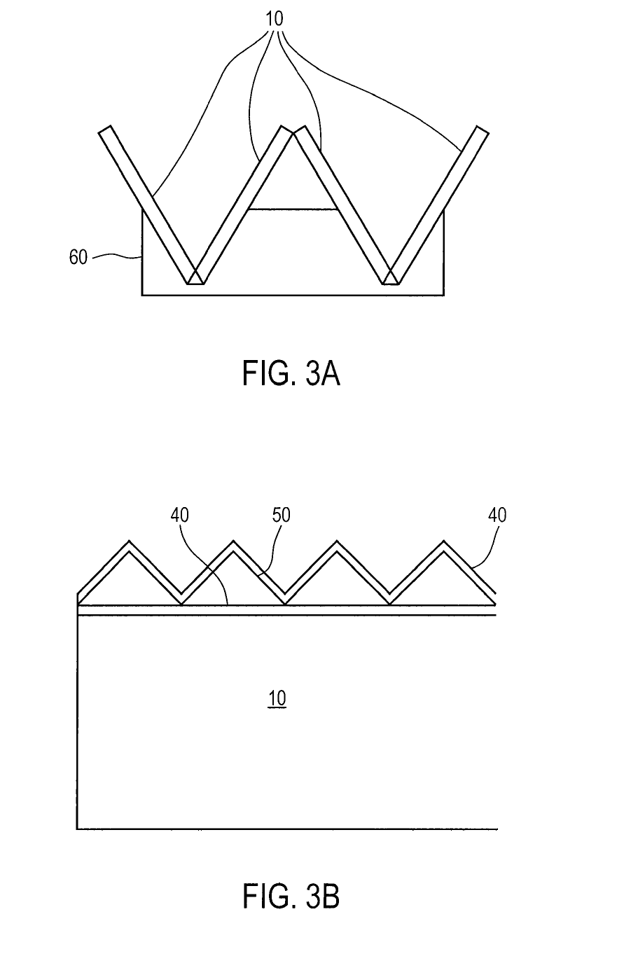

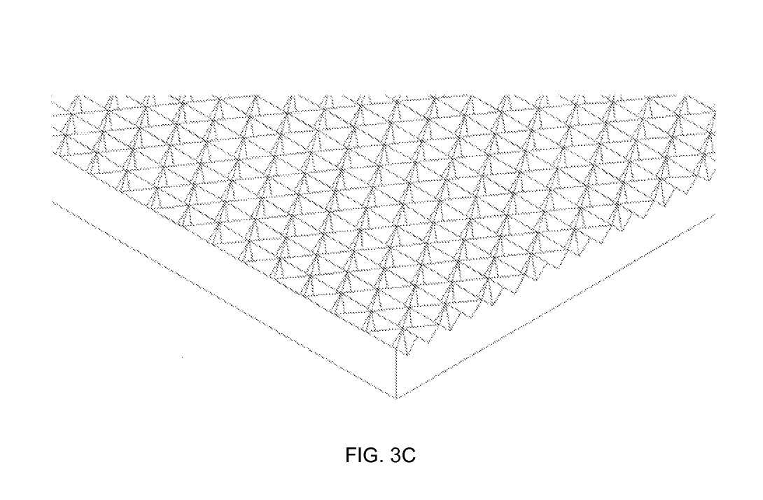

FIG. 3A is an illustration of a power beam receiver with the front surfaces arranged such that all incident radiation from within the receiver's acceptance angle that reflects from one surface is guaranteed to impinge upon a second surface, in accordance with one embodiment. In this figure, these surfaces are power conversion elements, but the arrangement can be used more generally. For example, the front surface might be an optic, which reflects onto a detector, as in FIG. 2B and FIG. 2C. In this embodiment, two power receiving elements 10 are angled toward each other. Any beam of light that reflects from the first surface will hit the second, regardless of which is the first surface. Anti-reflection coatings, such as those by Edmund Industrial Optics of Barrington, N.J., have approximately 2% reflection at 45 degrees. Any ray that hit the first surface, reflected, hit the second surface, and reflected back out, would be attenuated to 0.04%. Potential limitations to this system are the awkwardness of fixing power receiving elements 10 at right angles to each other and the risk for contamination of the surfaces. The resulting device may be thicker than is acceptable. Also, if water or oil accumulates on the surfaces of the power receiving elements 10, the reflectivity would increase. However, the arrangement illustrated in FIG. 3A is useful in reducing the total amount of reflections with which humans may come into contact.

FIG. 3B shows an improvement on the arrangement of FIG. 3A. In FIG. 3B, a series of small, hollow, anti-reflection coated corner cube reflectors 50 is placed before the power receiving element 10. FIG. 3C is an illustration of a power beam receiver where the front surface comprises corner cube retroreflectors.

Corner cubes are easy to make in plastic—bicycle reflectors are one example. A molded plastic piece can be made. If a finer scale is desired, a grayscale photolithographic process such as those used to make microlenses CCDs and CMOS imagers can be used. If the power beaming system uses a wavelength to which plastic is opaque, cast glass can be used. A reasonable thickness for the corner cubes is 1 mm, although many thicknesses can be used. When choosing the thickness of the corner cubes, considerations include making sure the corner cubes cannot easily be filled with liquid and sizing them such that they tend not to retain dust and dirt. A surface coating 40, such as an anti-reflection coating should be used on every exposed surface—the purpose of the structure is to reflect as little light as possible, but to be certain that any light reflected is back along the beam path. An additional type of surface coating 40 may also be used, such as an anti-scratch coating, as is commonly used on prescription eyeglasses. Note, that in this embodiment, the reflector is a hollow corner cube. A filled corner cube, such as would be obtained by cutting the corner off a glass cube, may be subject to contamination.

Note that in the embodiment shown in FIG. 3B, the power receiving elements 10 can now be laid flat, not angled, and that corner cube reflectors 50 can be quite thin. It is also safe against contamination. If water accumulates on both surfaces and the reflectance is very high, the beam would be reflected back along the path from which it came (except for some dispersion due to diffraction). Thus, in one embodiment, the transmitter is also designed not to reflect incident radiation unsafely, for example by use of baffles and/or anti-reflection coatings.

The embodiment of FIG. 2A may be superior when the light comes from a fixed position such that the beam is incident at a controlled angle, preferably perpendicular to the power beam receiver (which would be 45 degrees to front surface shown in FIG. 2A). The embodiment of FIG. 3B is advantageous when the angle of the light cannot be conveniently fixed.

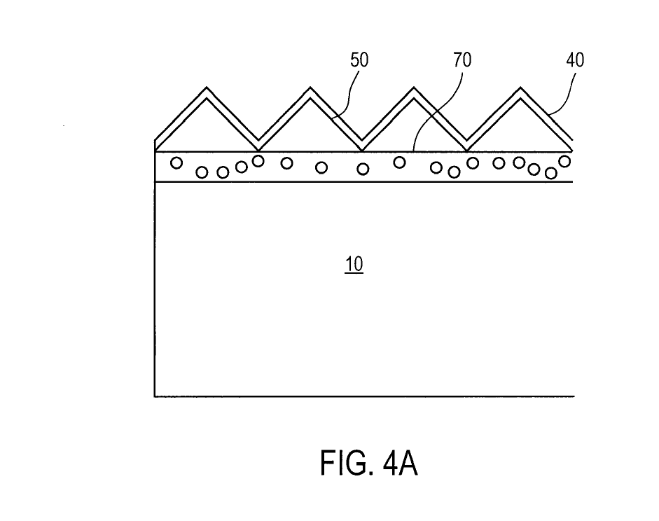

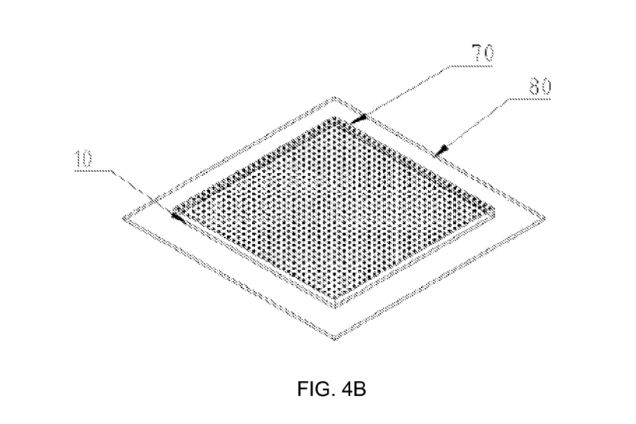

FIG. 4A is an illustration of a power beam receiver where an intentional dispersion element 70 is inserted to increase the angles of the incident light upon reflection, in accordance with one embodiment. FIG. 4A shows one position for a dispersion element 70. The dispersion element 70 can be a roughness present on or intentionally added to any surface. Alternatively, it can be extra material added between elements. Further alternatively, it can be within an element, such as glass balls molded into a plastic lens. One way to make the roughness is with a mechanical process, like sanding or grinding. Another way is to use a photoetch step on the surface of an element, such as a power receiving element 10. Still another way is to intentionally mark or scratch the mold or die from which a molded or cast part is made. The design of these scratches is often non-critical as long as they are not too deep. A more accurate method, like a photoresist method, can put features designed for diffraction into the optical system. The main design consideration for these defects is the tradeoff between efficiency—getting the light to where it will be converted to electricity—and safety. Any system where light propagates across regions with index differences is subject to Fresnel reflection, and so there will be an efficiency loss due to back reflection.

FIG. 4B shows a receiver with a dispersion element 70 and a border 80. When using a dispersion element 70, in one embodiment, a border 80 around the dispersion element 70 is used to guarantee that there is a minimum distance between a human eye or other human tissue and the surface from which the light is scattered. Because the beam path and the border are assumed to be protected, the closest a person can get to the light is the width of the border 80. Assume that a 32 mm×32 mm square has normal incident light at 1 mW/sq. mm. Assume that the reflection from the surface is 10% with equal scattering through a hemisphere (2π steradians). Assume that a person's pupil is 7 mm, and that their head cannot interfere with the beam but rather must be outside the border, which is 10 mm wide. The greatest amount of light that a 7 mm pupil could receive under these conditions is 0.016 mW, which is well within the regulatory exposure limits.

For efficiency, the front of the intentional dispersion element 70 should be anti-reflection coated, and it should be index-matched to the power conversion device 10. It can be best to have the dispersion elements exposed, as shown, so that contamination causing reflection will cause dispersed reflection. Power conversion device 10 is shown supported by a substrate, which forms border 80.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention. Therefore, the scope of the invention should be determined by the appended claims and their legal equivalents.

What is claimed is:

1. A power beam receiver comprising:
a power conversion element arranged at a non-perpendicular angle to an incident power beam; and
a first baffle arranged to absorb reflections of the incident power beam from the power conversion element.

2. The receiver of claim 1, wherein the incident power beam has a wavelength, and the first baffle absorbs light at least at the wavelength of the incident power beam.

3. The receiver of claim 1, wherein the first baffle comprises black anodized aluminum.

4. The receiver of claim 1, wherein the non-perpendicular angle to the incident power beam is an angle of approximately 45 degrees.

5. The receiver of claim 1, further comprising a reflector that focuses the incident power beam onto the power conversion element.

6. The receiver of claim 5, wherein the power conversion element is arranged at a non-parallel angle to the incident power beam, and the power beam receiver further comprises a second baffle arranged to absorb reflections of the incident power beam that have twice reflected from the reflector.

7. The receiver of claim 5, wherein the reflector comprises a parabolic reflector.

8. The receiver of claim 7, wherein the parabolic reflector comprises an off-axis parabolic reflector.

9. A power beam receiver comprising:
a first power conversion element arranged at a non-perpendicular, non-parallel angle to an incident power beam; and
a second power conversion element fixed at a right angle to the first power conversion element, wherein reflections of the incident power beam from the first power conversion element impinge on the second power conversion element.

10. A power beam receiver comprising:
a power receiving element arranged to receive an incident power beam; and
a retroreflector between a source of the incident power beam and the power receiving element.

11. The receiver of claim 10, wherein the retroreflector is anti-reflection coated.

12. The receiver of claim 10, wherein the retroreflector comprises a corner cube.

13. The receiver of claim 12, wherein the corner cube is anti-reflection coated.

14. The receiver of claim 12, wherein the corner cube is hollow.

15. The receiver of claim 14, wherein a thickness of the hollow corner cube retroreflector is approximately 1 mm.

16. The receiver of claim 10, further comprising a plurality of retroreflectors between the source of the incident power beam and the power receiving element, wherein the plurality of retroreflectors comprise a plurality of anti-reflection coated, hollow corner cube retroreflectors.

17. A power beam receiver comprising:
a surface of a first element; and
a surface of a second element, wherein the first and second elements are arranged so that light from an incident power beam that originally reflects from the surface of the first element is directed to the surface of the second element, wherein the first and second elements are not substantially reflective.

18. The receiver of claim 17, wherein the first element comprises a power receiving element.

19. The receiver of claim 17, wherein the first and second elements are afocal.

20. The receiver of claim 17, wherein the first and second elements are further arranged so that light from the incident power beam that originally reflects from the surface of the second element is directed to the surface of the first element.

21. A power beam receiver comprising:
a power receiving element arranged to receive an incident power beam; and
an intentional dispersion element between a source of the incident power beam and the power receiving element to scatter reflections of the incident power beam.

22. The receiver of claim 21, wherein the intentional dispersion element comprises a light-dispersive feature.

23. The receiver of claim 21, wherein the intentional dispersion element comprises a photoetched element.

24. The receiver of claim 21, further comprising a border around the power beam receiver.
